(19) United States
(12) Patent Application Publication
(10) Pub. No.: US 2008/0028230 A1
(43) Pub. Date: Jan. 31, 2008

(54) Biometric authentication proximity card

(75) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TRI-D Systems, inc., Pasadena, CA (US)

(21) Appl. No.: 11/800,352

(22) Filed: May 4, 2007

Related U.S. Application Data
(60) Provisional application No. 60/798,451, filed on May 5, 2006.

(51) Int. Cl. H04L 9/32

(52) U.S. Cl. 713/186

(57) ABSTRACT

A biometric proximity card and an access system cooperating with such card are disclosed. The card has a biometric sensor, and a memory storing a reference biometric datum, for example, a fingerprint, for an authorized user. Only when a biometric datum of an actual user matches the stored biometric datum, a pseudorandom PIN generator generates a one-time passcode that can be detected and validated by a door panel or other proximity sensor controlling access to a building or other resource.

### CROSS-REFERENCE TO RELATED APPLICATION

This application claims benefit of U.S.Provisional Patent Application No. 60/798,451, filed May 5, 2006, which is incorporated herein by reference in its entirety.

### BACKGROUND

Proximity cards are used for various purposes, including “physical” access to buildings and other facilities. In a typical example of a building access card, the holder of the card presents the card to an electronic door panel. The door panel reads a serial number, or other identification information, from the card and confirms that the card holder is authorized to have access to the building. The card may be in the general size of a credit card, older versions being thicker than a credit card and recent versions being the same thickness as a credit card. The card is usually a “passive” device and is powered, inductively, by the door panel transmitting power to a coil of an antenna in the card that is also used to transmit information from the card to the door panel. The card may also be an “active” device that carries batteries to power the card. Recently developed cards confirm the card's authenticity by exchanging information between the door panel and card in an encrypted form, sometimes using challenge-response architecture. Proximity cards typically contain small microprocessors, or chips, and are often called “prox cards” or RFID cards.

These prox cards are only a one-factor authentication method. That is, whoever has the card can gain access to the building. There is no other way to make sure the person holding the card is the person the card was actually issued to. If the card is lost or stolen, anyone can use it to gain access to the building.

In order to improve authentication to confirm the actual user, some door panels are including key-pads. The user must enter a PIN number, something only the authorized user should know, and also present the card, something only the authorized user should have. This is known as two-factor authentication. But this is still not enough to really confirm the identity of the holder of the card.

In order to improve authentication, some door panels are including a biometric reader, such as a fingerprint sensor. The user then presents the card and, in the case of fingerprints, present the appropriate finger or fingers to the door panel. If the fingerprint of the finger presented matches the one enrolled by the user when the card was issued, then the user is granted access to the building.

Adding biometrics sensors has many disadvantages; every access point to the building must get a new door panel with the added fingerprint sensor, the entire infrastructure for the software must be changed to support the sending and receiving of the biometric information, databases need to added to the system to store the “enrolled” biometric information, the door panel must be able to compare the fingerprint from the database with the fingerprint presented at the door panel, etc. The other disadvantage is the increase in time required by the users to present their fingers and have the fingerprints verified before they may gain access to the building. The time taken to authenticate and admit a single individual may not be large, but the cumulative delay can cause very long lines to form at the access door, especially at times when large numbers of people are arriving, for example, at a regular start of work or shift change, or when returning from lunch.

There is a need to improve building and facilities access, and wherever else a proximity card is used, with biometric authentication that does not require replacing the existing infrastructure, require the building and maintaining of central biometric databases, or increase the time needed to perform the authentication to gain access to the building.

### SUMMARY OF THE INVENTION

According to one aspect of the invention, there is provided a device comprising an authentication system for verifying that the user of the device is the authorized user, the authentication system comprising: a reader for sensing and reading a biometric datum of a user; a memory for storing an authorized biometric datum; a comparator, responsive to the reader and the memory, for comparing the read biometric datum to the stored biometric datum; and a wireless transmitter for sending an identifying signal to a receiving device when the read fingerprint and the stored fingerprint are equivalent.

According to another aspect of the invention, the device further comprises a pseudo-random generator, responsive to the comparator, for generating a pseudorandom personal identification number (PIN) when the read fingerprint and the stored fingerprint are equivalent; and in operation the wireless transmitter sends the pseudorandom PIN to the receiving device.

According to a further aspect of the invention, there is provided a building access control system comprising a proximity sensor arranged to obtain the identifying signal from the device comprising the authentication system, and arranged to give a user of the device access to a building or other facility when a correct identifying signal is received.

According to a further aspect of the invention, there is provided a method for verifying that a user of a device is an authorized user in order to allow or deny access, the method comprising the steps of sensing and reading a fingerprint or other biometric datum of a user of the device; comparing the read datum with a stored datum of the authorized user of the device; generating a pseudo-random personal identification number (PIN) when said read fingerprint is equivalent to the stored fingerprint, said PIN being used to verify activation of said device; and transmitting the pseudo-random PIN to a proximity sensor of an access control system.

According to a further aspect of the invention, there is provided a system and method for verifying that a user of a device is an authorized user in order to allow or deny access, an authentication system for verifying that the user of the device is the authorized user comprises: a reader for sensing and reading a biometric datum of a user; a memory for storing an authorized biometric datum; a comparator, responsive to the reader and the memory, for comparing the read biometric datum to the stored biometric datum; a wireless transponder responsive to a proximity sensor for sending an identifying signal to the proximity sensor when the read fingerprint and the stored fingerprint are equivalent; and a power supply on the device to enable the device to commence reading and comparing the biometric datum before entering an operative proximity of the proximity sensor.

### BRIEF DESCRIPTION OF THE DRAWINGS

FIG. 1 is a schematic view of one form of a Biometric Prox Card in the form of an ID badge.

FIG. 2 is a pictorial representation of one form of Biometric Prox Card with antenna enabling method.

FIG. 3 is an illustration of a Biometric Prox Card with an added smartcard module.

FIG. 4 is an illustration of a Biometric Prox Card with added smartcard module and additional flexible display.

FIG. 5 is a rear view of a Biometric Prox Card showing a magnetic stripe.

FIG. 6 is an illustration of a Biometric Prox Card with added smartcard module, additional flexible display, and numeric PIN pad.

FIG. 7 is a block diagram depicting a Biometric Prox Card in accordance with one preferred embodiment of the invention.

FIG. 8 is a flow diagram depicting a method of activating the card in accordance with a preferred embodiment of the present invention.

FIG. 9 is a block diagram of an exemplary issuer network in accordance with a preferred embodiment of the present invention.

### DETAILED DESCRIPTION OF THE DRAWINGS

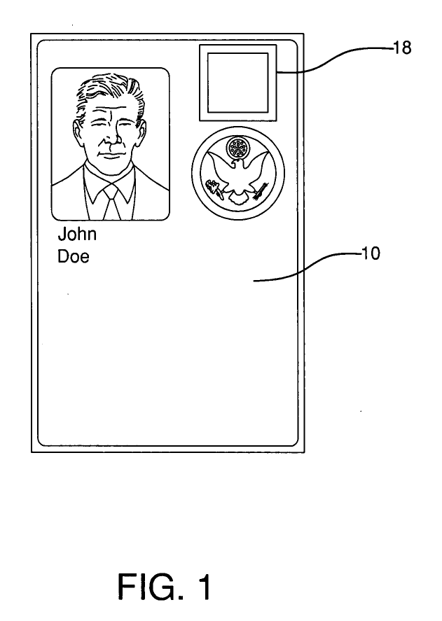

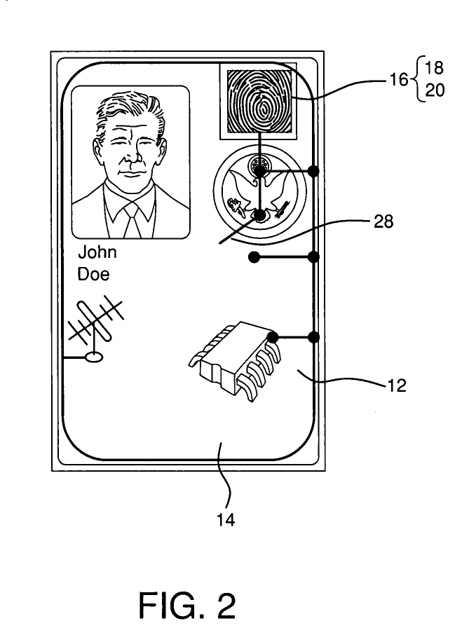

Referring to the drawings, and initially to FIGS. 1, 2, and 7, one form of the Biometric Authentication Proximity Card (Biometric Prox Card) 10 is a card the size of a credit card containing an RFID chip 12, an antenna 14, a biometric fingerprint sensor 16 comprising a sensing area 18 and a reader 20, a power source 22, a microprocessor 24, memory 26, and a switch or other device 28 to activate the RFID chip 12.

As explained below, the power source 22 is coupled to all components of the card 10 that require a power source in order to function when no external power supply is available, for example, the fingerprint sensor 16, microprocessor 24, and clock 34. The power source 22 may be any power source, such as a battery, or a solar cell, or combinations thereof which are small enough to fit in a standard size credit card, and powerful enough to provide enough power to the components requiring such. A capacitor may also be used in combination with the power source, providing any delta in the required power provided by the power source during activation and use.

The RFID chip 12 and antenna 14 may be the same as, or very similar to, the RFID chips already used in non-biometric proximity cards (not shown). Therefore, in an existing system the door panels (not shown in FIG. 1) do not need to be replaced in order to use the Biometric Prox Cards 10, and both the existing proximity cards and new Biometric Prox Cards 10 can be used to gain access. That can ease the transition as Biometric Prox cards can be gradually issued to replace the non-biometric cards. That can also permit the use of both non-biometric and Biometric Prox Cards in parallel. For example, in a facility with areas having different levels of security, both Biometric Prox Cards and non-biometric prox cards might be accepted for access to the outer perimeter of the or other less-secure areas, while requiring the use of a Biometric Prox Card for access to more secure areas of the building without the need to change any of the existing infrastructure.

The reader 20 of the fingerprint sensor 16 will read the fingerprint on a finger applied to the sensing area 18, and send an image or other electronically processable representation of the fingerprint to the microprocessor 24 for analysis. The fingerprint sensor 16 will fit into the credit card sized Biometric Prox Card 10, permitting the Biometric Prox Card to meet all of the requirements and specifications of a smartcard.

The battery 22 will be used to power the fingerprint sensor 16 and microprocessor 24. The battery 22 will fit into the credit card sized Biometric Prox Card 10, permitting the Biometric Prox Card to meet all of the requirements and specifications of a smartcard. The battery may also be used to power the means by which the RFID chip is enabled. The battery may also be used to power the RFID chip, depending on the type of RFID chip used.

In operation, the microprocessor 24 is programmed to receive the image from the fingerprint sensor 16, compare the received fingerprint to a fingerprint image obtained when the Biometric Prox Card was initially issued to the user and stored in the memory 26, optionally using a dedicated comparator unit 30, and determine if the images match.

If the fingerprints match, the microprocessor 24 enables the RFID chip 12. The microprocessor 24 will fit into the credit card sized Biometric Prox Card, permitting the Biometric Prox Card to meet all of the requirements and specifications of a smartcard.

The memory 26 may be contained in the microprocessor 24, and may be used to store the originally enrolled fingerprint information, other information about the behavior of the user, parameters as to the use of the card, and potentially information for generating one-time-passcodes or other cryptographic information, such as PKI, etc.

In an embodiment, the information transmitted by the RFID chip 12 when the fingerprint is correctly authenticated includes a one-time passcode generated by a pseudo-random number generator 32. The pseudo-random number generator 32 may use a sequence-based algorithm, in which case the most recent number in the sequence is stored in memory 26, or a time-based algorithm using a real-time clock 34 powered by the battery 22.

The mechanism by which the RFID chip 12 is enabled may vary and will depend on the type of door panel or other sensor with which the Biometric Prox Card is to be used. This mechanism may be a switch that is in parallel to the connection of the antenna 14 to the RFID chip 12, thereby shorting the antenna and not permitting the inductive coil of the antenna to power up the RFID chip, and/or not permitting communications from the antenna to reach the RFID chip, and/or not permitting communications from the RFID chip to be transmitted by the antenna. The mechanism may be a switch in series with the antenna 14, thereby disconnecting the antenna from the RFID chip 12. In the case of an “active” RFID chip, the mechanism 28 may be a switch that supplies power to the RFID chip 12. The mechanism 28 may be an “enabling” signal from the microprocessor 24 to the RFID chip permitting it to function.

The mechanism 28 may be an “enabling” signal to the RFID chip indicating that the biometric information has been verified and thereby allowing the RFID chip to alter the type or amount of information it sends to, or exchanges with, the door panel. In the “disabled” state, the RFID chip 12 may then send to the door panel a message explicitly indicating that no fingerprint, or an apparently wrong fingerprint, has been presented for authentication. The mechanism 28 can include the filtering of information the RFID chip wants to send or the interjection of additional information into the communications from the RFID chip to the door panel. The mechanism 28 may be shielding on the antenna which can block the antenna coil from receiving enough power for the RFID chip and/or from sending or receiving any communications with the door panel.

The mechanism 28 may comprise supplying a one-time passcode from the pseudorandom number generator 32 to the RFID chip 12 only if the user's fingerprint has been correctly authenticated.

The fingerprint can be verified on the card 10, and the mechanism 28 to enable the RFID chip can be activated, prior to the user reaching the door panel, and the RFID chip can stay enabled for a specific period of time, commonly one minute, as a selected parameter for each Biometric Prox Card. Therefore the user can enable the Biometric Prox Card as the user approaches the door panel and can gain entry the same way as with a standard proximity card. That can avoid any additional delays in gaining access and reduce the potential for developing lines of people waiting to gain access.

It is not necessary for a battery or other on-card power supply 22 to be provided. Instead, the Biometric Prox Card 10 can be powered by induction through the antenna 14. However, the authentication of the user's fingerprint cannot then commence until the card 10 is within the induction field of the door panel or other fixed sensor. To avoid exposing users to undesirable levels of electromagnetic fields, the distance from the door panel at which an adequate induction power supply is available may be limited, so in that configuration the rate at which users can be verified and pass through the controlled access door may be lower than for battery-powered cards 10. Where a battery 22 is provided, the battery may power only parts of the card 10, and/or the card may transfer to inductive power when the card 10 comes within the operating proximity of the door panel.

In another form of the Biometric Prox Card 10, the chip 12 may be a WiFi chip and/or a Bluetooth chip instead of an RFID chip, or may include Bluetooth, WiFi, and/or another wireless protocol in addition to RFID. This will extend the use of the card for both “physical access” and for “logical access”, as for authentication of the user to a computer or laptop as part of the login process.

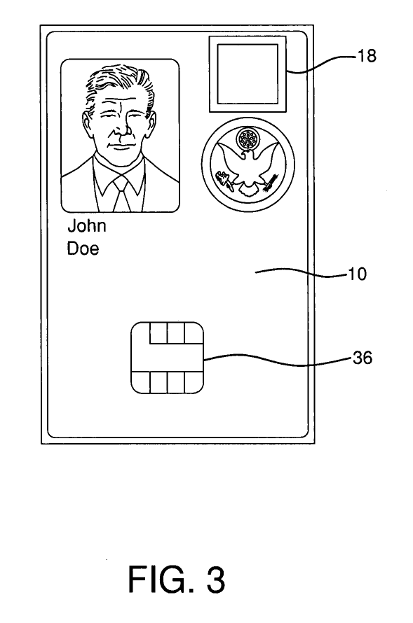

Referring to FIG. 3, another form of the Biometric Prox Card 10 is similar to the card shown in FIG. 1, but includes a smartcard module or smartcard chip 36, with exposed contacts 38. This form of smartcard is known for credit cards and the like. The smartcard chip 36 is typically powered through power contacts on the contact pad 38. Recent U.S. government ID card specifications are requiring the inclusion of both an RFID chip 12 and a smartcard chip 36. In addition to enabling or disabling the RFID chip 12, the Biometric Prox Card 10 can also enable or disable the smartcard chip 36 in response to the authentication or non-authentication of the user's fingerprint.

The mechanism to enable the smartcard chip 36 can be similar to any of the mechanisms 38 described above by which the RFID chip 12 is enabled or disabled. For example, the mechanism to enable the smartcard chip 36 can be a switch so that the smartcard chip cannot receive power from a smartcard reader (not shown). The mechanism to enable the smartcard chip 36 can be a switch so that the smartcard chip does not receive a RESET signal from the smartcard reader. The mechanism can include the filtering of information the smartcard chip receives from the smartcard reader and/or wants to send to the smartcard reader, or the interjection of additional information into the communications between the smartcard chip and the smartcard reader. The mechanism can include information the microprocessor 24 sends to the smartcard chip 36 that the smartcard chip can send directly to the smartcard reader, that the smartcard chip can use to enable certain features of the smartcard chip, that the smartcard chip can alter or encrypt before it is sent to the smartcard reader, that the smartcard chip can use as a seed for random number generation or as a challenge and response to the smartcard reader, or a number of other methods.

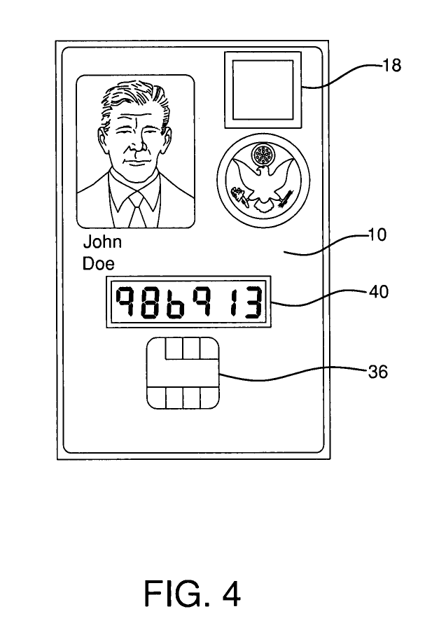

Referring to FIG. 4, another form of the Biometric Prox Card 10 can include a display 40. The display 40 will fit into the credit card sized Biometric Prox Card 10, permitting the Biometric Prox Card to meet all of the requirements and specifications of a standard smartcard. The display can be used to indicate the status of the card 10. This status can include whether the fingerprint presented to the card matched the fingerprint enrolled into the card when it was issued to the user. The status can include a timer, which may be driven by the clock 34, indicating how long the RFID chip 12 and/or smartcard chip 36 will be enabled. The display 40 can also be used to display messages to help guide the user for the enrolling of the fingerprint into the card, and messages for using the card during verification of the fingerprint. The display can also be used for information needed so that the user can verify his or her identity where an RFID door panel or smartcard reader is not available. This information can be in the form of a one-time-passcode (OTP), or any other form familiar to the industry for display tokens.

Another form of the Biometric Prox Card can include a simple go-no go indicator 42. This indicator can be a simple LED that indicates when the presented fingerprint matches the fingerprint enrolled in the Biometric Prox Card.

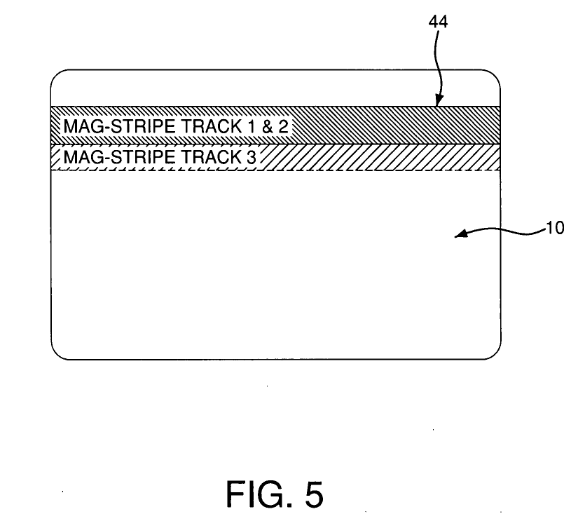

Referring to FIG. 5, another form of the Biometric Prox Card 10 includes a magnetic stripe 44, which may be in the format known for credit cards, ATM cards, and the like. The magnetic stripe 44 can provide additional information about the card holder. The magnetic stripe 44 can be enabled by the microprocessor when the biometric information has been verified. The information available on the magnetic stripe can vary. The magnetic stripe 44 can provide no information until the fingerprint is verified, a limited amount of information before verification and additional information after verification, information before verification and completely different information after verification, variable information after verification such as an OTP, or any combination of these. The information presented can also be erased from the magnetic stripe after a preset amount of time. As shown in FIG. 5, the magnetic stripe 44 may be in two parts, Tracks 1 and 2 between 5.54 mm and 11.89 mm from the long edge of the card, and Track 3 between 11.89 mm and 15.82 mm from the edge of the card, in accordance with the existing standards.

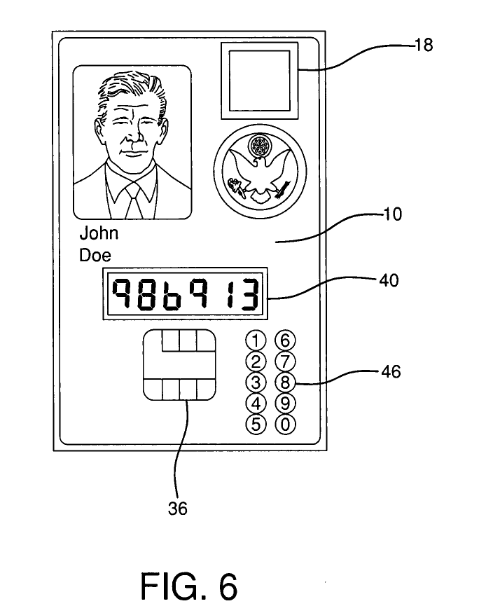

Referring to FIG. 6, another form of the Biometric Prox Card 10 will include a PIN pad 46 on the card. Where full three-factor authentication is required, the holder of the card may need to first enter a PIN number (something the user knows) onto the card (something the user has) to activate the fingerprint sensor, and then verify the user's fingerprint (something the user is) before the RFID chip 12, smartcard chip 36, etc. is enabled to issue a valid signal authenticating the card holder to a door panel, smartcard reader, or other sensor. The keypad 46 may also be used to enter other information and/or instructions into the card 10.

The enrollment of the fingerprint into the card can be performed with many different methods. One method is to enroll the fingerprint directly into the card without the need for any other readers or external devices. This method works very well if the card includes a display 40 to help guide the user through the enrollment process. One method uses the go-no-go indicator 42, which can be caused to guide a user by using flashes or specific sequences of flashes as signals. One method would be to use a smartcard reader or RFID reader to assist with the enrollment process. With these methods an external device can provide the messages to guide the user through the enrollment process while using the fingerprint reader on the card. With this method the fingerprint could also be enrolled on an external device and then loaded into the card.

During the enrollment process, the fingerprint or other biometric data of the authorized user of the card are captured and stored in the memory 26. The enrollment process may then be disabled, or the memory 26 may be a non-erasable memory, or a memory that cannot be erased without also erasing other data needed for the successful use of the card 10. Alternatively, where the enrollment process requires an external device, the external device may be kept secure. The objective is that a person who comes into unauthorized possession of the card 10 should not be able to replace the authorized user's biometric data with the unauthorized user's biometric data, or at least not without efforts disproportionate to the value of the card.

Although Biometric Prox Card 10 has been described primarily as a building access card, associated with a single card issuer, it should be noted that card 10 may be used for other purposes, or for multiple purposes, and may comprise information about the cardholder in association with a plurality of card issuers. For purposes of this disclosure, a “card issuer” is defined as any business or organization capable of associating a card holder with the business's or organization's services using the identifying information provided by the card, including information on the front of the card 10, on the magnetic strip 44 on the back of the card 10, in the memory 26, or in any of the chips 12, 24, 36, etc.

In one embodiment, the clock 34, coupled to the CPU 24 and the pseudorandom number generator 32, forwards the clock signal to the pseudorandom number generator 32. Random generator 32, coupled to CPU 24, and clock 34, generates a pseudo-random code each time card 10 is activated by an authorized cardholder. A code generator algorithm is used by random generator 32 in order to generate a pseudo-random code that can be duplicated by a psuedo-random generator at a card issuer's network. Where the code generated by random generator 32 is human-readable, the code is preferably an alphanumeric code, but a code having only numbers or only letters may also be generated. Where the code is processed entirely electronically, for example through the RFID chip 12 and antenna 14 or through the smartcard chip 36 and contact pad 38, a binary code may be used. It is preferable that the code generator algorithm be distinct for each cardholder, thereby ensuring that the code generated by random generator 32 is associated with the authorized cardholder. For example, the pseudorandom number generating algorithm, or an encryption algorithm used to encrypt the pseudorandom number after the number has been generated, may be a standard algorithm, but using a seed or key that is unique to the individual user.

CPU 24 may forward an authorization signal to random generator 32 once CPU 24 confirms that the user is the authorized cardholder. Based on the code generator algorithm, which could be, and is preferably, different for each of a plurality of cardholders, random generator 32 then generates a random code, which is then used as the PIN for the card during the next transaction. Preferably, another code is generated each time the card senses the touch of a thumb or finger, and the generated code is valid only for the single transaction, thereby requiring a new code for each transaction. Display 40, if present, may receive the PIN number from random generator 32 and display the number to the cardholder.

If CPU 24 forwards an authorization signal that indicates the user is not the authorized cardholder, display 40 may display an error message. RFID chip 12 or smartcard chip 36 may emit an error message. Alternatively, when the user is found to be unauthorized, display 40, RFID chip 12 or smartcard chip 36 is not activated.

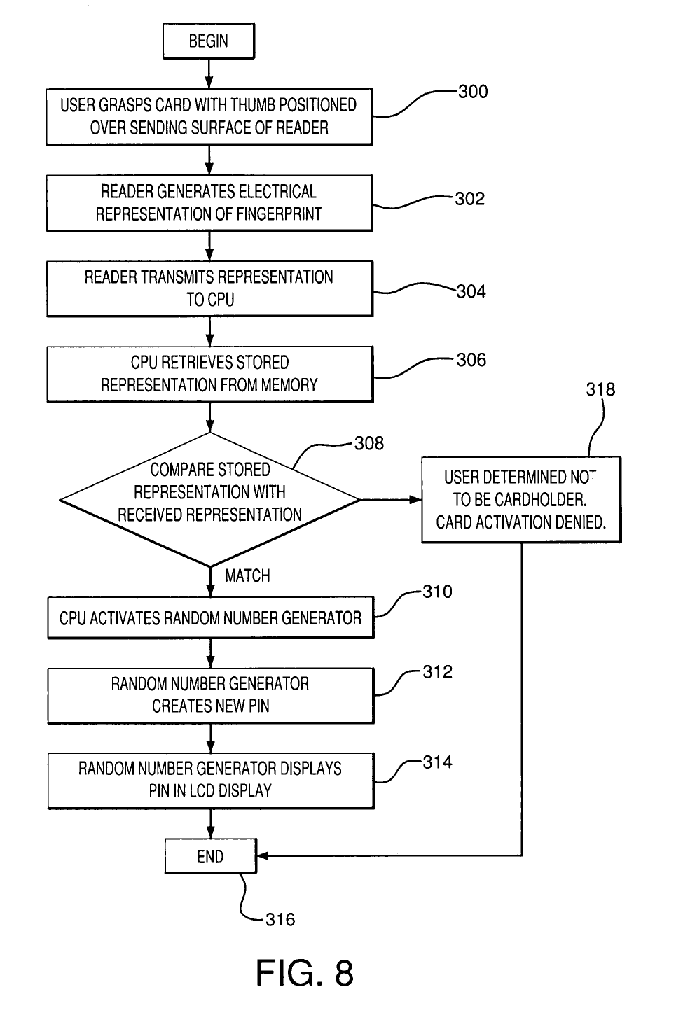

Referring now to FIG. 8, in an embodiment, wherein the operation of the disclosed invention is exemplified, without intended limitation, in step 300 reader 20, coupled to CPU 24, sensing area 18 and power source 22, receives a signal from sensing area 18 indicative of the presence of a finger on its surface, for example the thumb of the user. In step 302, in response to receipt of a signal from sensing area 18, reader 20 translates the biometric signal, e.g., the imprint from the finger or thumb, into a fingerprint signal that in step 304 is forwarded to CPU 24 along with a signal requesting the activation of card 10 (verification of an authorized user). The method by which reader 20 translates the fingerprint of the user into a usable signal may be any method known in the art or hereafter to be developed for reading fingerprints electronically.

In step 306, CPU 24 then forwards a request signal to memory 26 in response to the request for activation by reader 20. Memory 26, coupled to CPU 24, stores, for example, an authorized fingerprint signal of the authorized cardholder, which it receives after initialization by CPU 24. Once memory 26 receives a request signal from CPU 24, memory 26 forwards the stored authorized fingerprint signal to CPU 24. CPU 24 then forwards the fingerprint signal from reader 20 and the authorized fingerprint signal from the memory 26 to comparator 30.

In step 308, comparator 30 receives the signals from CPU 24 and determines whether the user is the authorized cardholder. Comparator 30 compares the signals received from CPU 24 relating to the stored and generated fingerprint representations, and outputs a signal to CPU 24, which is indicative of whether the stored fingerprint representation is equivalent to the generated fingerprint representation.

If the signal from comparator 30 indicates that, based upon the user's fingerprint or other biometric signal (together with a PIN entered on keypad 46 if applicable), the user is the authorized cardholder, then in step 310 CPU 24 activates pseudorandom number generator 32, which in step 312 generates a PIN number. In step 314 the PIN number is sent by the RFID chip 12 and the antenna 14 to the door panel, displayed to the user on display 40 if applicable, or otherwise provided for use. In step 316, access is granted to the building or other resource protected by the system, and the process ends. If in step 308 the comparison of stored and input data fails, then in step 318 it is determined that the user of the card is not the authorized card holder, the authenticating PIN is not generated, and an error or alarm message may be generated.

In practice as exemplified above, preferably but without intended limitation, the user must first initialize card 10 before the user is able to use card 10 to conduct any transactions. One non-limiting example of an initialization and enrollment procedure is as follows, although other procedures may be used instead. The user must first remove a protective covering from the surface of card 10. Zeros will flash in the display 40. The user then presses a first finger onto the sensing area 18. Programming within the card will confirm that it appears to be a fingerprint and will flash, e.g., 1 in the display. The user then removes his/her first finger and the card will display a steady first number. The first finger is again pressed onto the sensing area a second time which results in a second number flashing on the display. The first finger is again removed from the sensing area. The process is again repeated and the user presses the first finger onto the sensing area a third time, and, a third number will then flash. If the three readings all compare, as the same or equivalent, a fourth number is displayed.

If the readings do not compare and are not equivalent, the third number remains steady and unchanged. To activate card 10 the user will need to continue to press the sensing area until the fourth number is displayed. Once the fourth number is displayed, the user may activate the card. This may involve using practices commonly used by credit card companies, such as calling an 800 telephone number and entering personal information and information from the card. In the case of a building access card, activation may involve the user appearing in person with the card at a building security office with a sensor that can read the RFID transmission from the card. The user will then be asked to place his/her first finger on the sensing area of the card to generate a PIN number displayed on the card. If the PIN number generated by card 10 is correct, card 10 is ready for use.

Although the card has been described as requiring only a first fingerprint, a second fingerprint or a thumbprint may also be used to provide further protection against the unauthorized use of the card. Accordingly, although the exemplified embodiment is disclosed for simplicity in terms of a “fingerprint,” the term is broadly intended to include the alternative use of other digits, and to include the use of more than one digit.

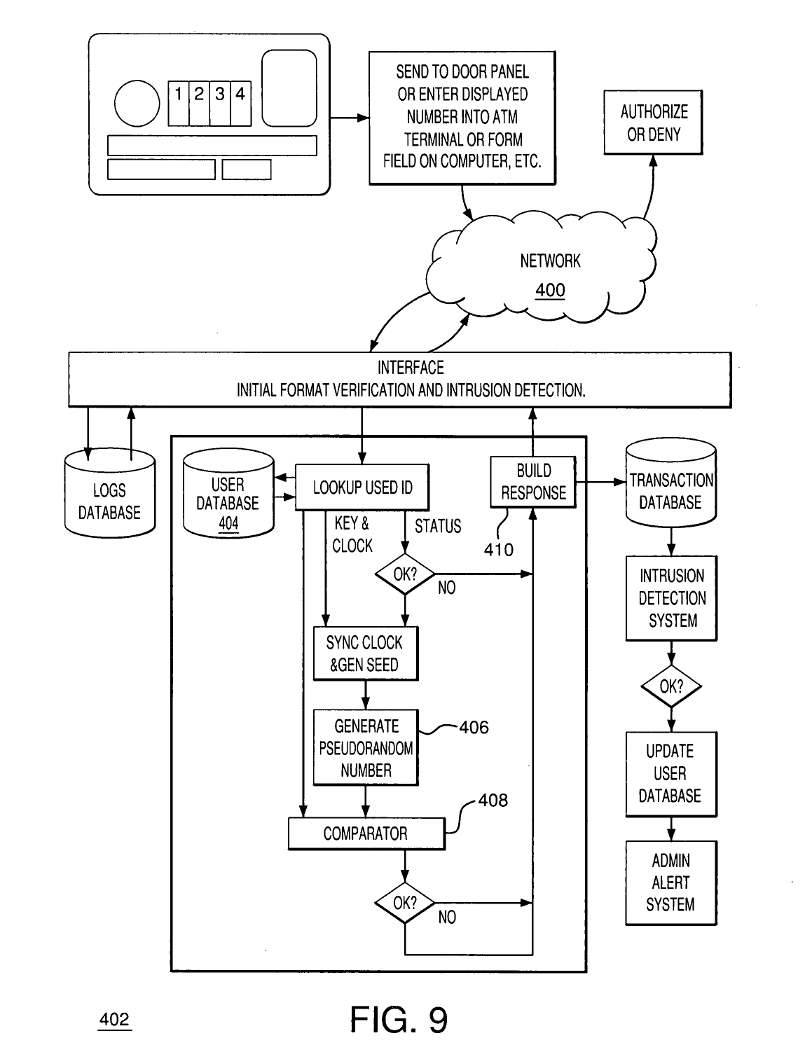

Once the card has been activated, and card 10 has generated a PIN number for a transaction, the PIN number may be sent by the RFID chip 12 to the door panel or other sensor. Alternatively, the PIN number may be displayed on the display 40, and the user may enter the PIN number into a card terminal or form field on a computer, for example. The PIN number entered by the cardholder is then forwarded to the device issuer or other authenticating server through a network coupled to the device used by the cardholder to enter the PIN number. FIG. 9 is an exemplary block diagram of an issuer network in accordance with an embodiment of the present invention. The issuer network utilized in the exemplary system shown in FIG. 9 may be a network for a credit card issuer, or may be a building access control network. The issuer network may be associated with any device issuer. The “issuer” may be any entity that causes or permits users to be provided with cards 10, and that authenticates Biometric Prox Cards 10 when a user attempts to use such a card. Network 400 may be any means of connecting a user to a device issuer, for example, the internet, a LAN, or the credit card and ATM networks. In the case of a building access control system, the “network” 400 may be dedicated wiring within the building. Network 400 forwards PIN number and other relevant available information to the card issuer's network 402 for verification and authorization. The card issuer's network 402 comprises a user database 404, an issuer pseudorandom number generator 406, a comparator 408 and a response generator 410. The information forwarded by network 400 is received by user database 404, which looks up the user's account. If card 10 is a credit or debit card being used to purchase an item from a merchant, customer database 404 also confirms that the available credit is greater than the amount of the transaction. A verification signal is then generated by database 404, and forwarded to the response generator 410 indicating whether the card is valid, and, if applicable, whether the transaction meets the card issuer's criteria. Customer database 404 also forwards an initialization signal to the issuer generator 406, which preferably comprises the cardholder's code algorithm.

Issuer generator 406 then generates an issuer code in accordance with the stored code algorithm of the cardholder. This issuer code, along with the PIN number received from the cardholder, are forwarded to the issuers comparator 408 and compared. If the PIN number from the cardholder and the issuer's code are the same, comparator 408 forwards an authentication signal indicative of the authentication of the cardholder to the response generator 410. Otherwise, the authentication signal indicates that the cardholder is not authorized to use the card, thereby refusing the transaction or refusing the cardholder remote access for example.

Although a preferred embodiment is described as a card, any device may be utilized having an authentication system as disclosed herein, e.g., a keyfob.

This invention reduces the cost and complexity of implementing and maintaining a 3-Factor solution in two ways. First, because the user's PIN is simply entered onto computer log-on screens or existing Mag swipe, smart card, or prox readers, or onto a key-pad on the card 10 itself, there is no need to install and maintain expensive biometric readers at the point of transaction. Also, while special readers are not required to use the present invention, it can also work with existing prox, magnetic swipe or Smart Card readers and with ATM machines.

Second, the highly complicated and expensive undertaking of creating and maintaining a database of biometrics is not required because the fingerprint image is stored and matched only on the card itself. The card generates a one-time PIN code when there is a positive match and it is this PIN that is verified by the system, not the biometric. An additional benefit of this feature is that the user's biometric identity remains completely private and within his control. Privacy is further assured because the fingerprint is never transmitted off the device to a reader.

The above description and the views and material depicted by the figures are for purposes of illustration only and are not intended to be, and should not be construed as, limitations on the invention. Moreover, certain modifications or alternatives may suggest themselves to those skilled in the art upon reading of this specification, all of which are intended to be within the spirit and scope of the present invention as defined in the attached claims.

For example, the card 10 is shown as bearing various visible indicia on its face. As shown in FIG. 1, those indicia comprise the name and photograph of the authorized holder, an identification of an organization to whose facility the card provides access, and an identification of a supplier of the card 10. Any of those indicia may be omitted, or any desired additional indicia may be provided. For example, the card 10 may bear an identification number, which may identify the card or the cardholder in a network of a card issuer or facility operator. This number may be associated with any type of card issuer, for example, a credit card issuer, an internet service provider, on-line service provider, a drivers license, a debit card, an ID card, and the like. For exemplary purposes, the card and identification number may be associated with a credit card issued by a bank, although any issuer of an authentication card in accordance with the present invention may be utilized. Accordingly, the visible indicia may also comprise a predetermined date after which the card is no longer valid.

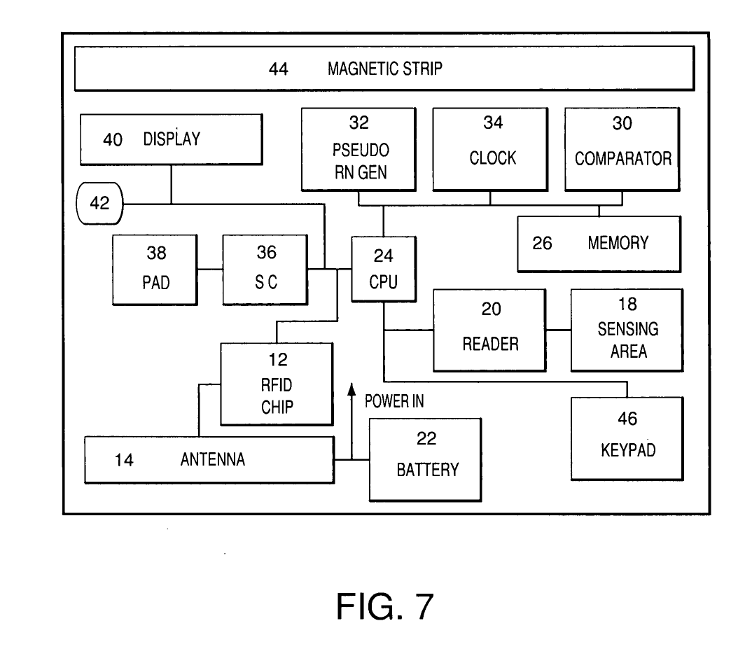

Although various components are illustrated in FIG. 7 as separate from one another, any or all of various components, including RFID chip 12, fingerprint reader 20, microprocessor CPU 24, memory 26, comparator 30, pseudorandom number generator 32, clock 34, smartcard chip 36, if present, may be combined as one component or fewer components than in FIG. 7, or a single component shown in the drawings may be subdivided into two or more components, any or all of which may be combined with other components.

Where the card has multiple functions, different PINs or other identifying signals may be generated, either in response to different interrogations in a challenge-and-response system, or depending on which of the RFID chip 12, smartcard chip 36, or display 40 is used to output the identifying signal.

When the Biometric Prox Card 10 is used as an access control card 10 in a facility with areas having different levels of security, the Biometric Prox Card 10 may be programmed to emit either a standard prox card identity number or a pseudorandom PIN. Then, at the outer perimeter of the facility or other less-secure areas where both Biometric Prox Cards and non-biometric prox cards are accepted, conventional door panels may be used that merely check the card identity number against a fixed list. For access to more secure areas of the building, a challenge-and-response door panel that will require the pseudorandom PIN may be provided. Thus, Biometric Prox Cards with a pseudorandom PIN can be introduced in the secure areas, without the need to change any of the existing infrastructure in the less secure areas. Even if the entire facility is required to support pseudorandom PINs, only the server software that authenticates the identity numbers of cards presented needs to be upgraded, and existing door panels can continue to be used.

1. A device comprising an authentication system for verifying that the user of the device is the authorized user, the authentication system comprising:
a reader for sensing and reading a biometric datum of a user;
a memory for storing an authorized biometric datum;
a comparator, responsive to the reader and the memory, for comparing the read biometric datum to the stored biometric datum;
a pseudo-random generator, responsive to the comparator, for generating a pseudorandom personal identification number (PIN) when the read fingerprint and the stored fingerprint are equivalent; and
a wireless transmitter for sending an identifying signal comprising the pseudorandom PIN to a receiving device when the read fingerprint and the stored fingerprint are equivalent.

2. The device of claim 1, wherein said pseudo-random generator generates said PIN in accordance with a user specific algorithm.

3. The device of clam 1, further comprising at least one of a display for displaying an identifying signal for a user to relay to a receiving device and a smartcard interface for sending an identifying signal to a receiving device.

4. The device of claim 1, in combination with an access control system comprising:
at least one proximity card sensor arranged to receive the identifying signal from the said device;
a user database having information for a plurality of users;
an issuer identifying signal generator, responsive to said user database, for providing a user code corresponding to the said device; and
an issuer comparator, coupled to said user database and said issuer generator, for comparing said user code to the identifying signal, wherein the user is authorized and the device activation verified to allow access when said user code is equivalent to said identifying signal.

5. The device of claim 1, wherein said device has the external dimensions of a standard credit card being readable by a standard credit card reader.

6. The device of claim 5, wherein said device is a smart card.

7. The device of claim 1, which is a proximity card arranged to be activated inductively when in the proximity of a proximity card reader.

8. The device of claim 7, further comprising an on-card power supply for at least the reader and comparator, so arranged that a user approaching such a proximity card reader can commence verification that the user's biometric datum is equivalent to the authorized biometric datum before the card is activated inductively.

9. A method for verifying that a user of a device is an authorized user in order to allow or deny access, the method comprising the steps of:
sensing and reading a fingerprint of a user of the device;
comparing the read fingerprint with a stored fingerprint of the authorized user of the device;
generating a pseudo-random personal identification number (PIN) when said read fingerprint is equivalent to the stored fingerprint, said PIN being used to verify activation of said device;
and transmitting the pseudo-random PIN to a proximity sensor of an access control system.

10. The method of claim 9, wherein said PIN is generated in accordance with a user-specific algorithm.

11. The method of claim 9, further comprising transmitting said PIN to an issuer of said device, wherein said issuer grants said access when said PIN is equivalent to a issuer generated code.

12. The method of claim 11, further comprising: generating a pseudo-random user code in response to the receipt by said issuer of said PIN; comparing said user code to said PIN; verifying said user and activation of said device for access when said user code is equivalent to said PIN.

13. The method of claim 9, wherein said access comprises at least one of access to information and physical access to premises.

14. A device comprising an authentication system for verifying that the user of the device is the authorized user, the authentication system comprising:
a reader for sensing and reading a biometric datum of a user;
a memory for storing an authorized biometric datum;
a comparator, responsive to the reader and the memory, for comparing the read biometric datum to the stored biometric datum;
a wireless transponder responsive to a proximity sensor for sending an identifying signal to the proximity sensor when the read fingerprint and the stored fingerprint are equivalent; and
a power supply on the device to enable the device to commence reading and comparing the biometric datum before entering an operative proximity of the proximity sensor.

15. The device of claim 14, which is arranged to be powered at least in part by power from the proximity sensor when the device is in the operative proximity of the proximity sensor.

16. The device of claim 14, further comprising a pseudo-random generator, responsive to the comparator, for generating a pseudorandom personal identification number (PIN) when the read fingerprint and the stored fingerprint are equivalent; and wherein the identifying signal comprises the pseudorandom PIN.

17. The device of claim 14, in combination with an access control system comprising:
at least one proximity card sensor arranged to receive the identifying signal from the said device;
a user database having information for a plurality of users;
an issuer identifying signal generator, responsive to said user database, for providing a user code corresponding to the said device; and
an issuer-comparator, coupled to said user database and said issuer generator, for comparing said user code to the identifying signal, wherein the user is authorized and the device activation verified to allow access when said user code is equivalent to said identifying signal.

18. The device of claim 14, wherein said device has the external dimensions of a standard credit card being readable by a standard credit card reader.
